(19) United States
(12) Patent Application Publication
(10) Pub. No.: US 2025/0364696 A1
(43) Pub. Date: Nov. 27, 2025

(54) ADVANCED POLYMER COATINGS FOR BUSBAR APPLICATIONS

(71) Applicant: Martinrea International US Inc., Auburn Hills, MI (US)

(72) Inventors: Murali S. Chandrasekhar, Rochester Hills, MI (US); Anindya Banerji, Windsor (CA); Cory Doble, Ortonville, MI (US)

(21) Appl. No.: 19/215,824

(22) Filed: May 22, 2025

Related U.S. Application Data
(60) Provisional application No. 63/651,482, filed on May 24, 2024.

(51) Int. Cl. H01M 50/505; B05D 1/26; C23C 2/06; H01M 50/526

(52) U.S. Cl. CPC H01M 50/505; B05D 1/265; C23C 2/06; H01M 50/526

(57) ABSTRACT

A multilayer Busbar coating system, in which individual layers are tailored to address functional requirements of electrical insulation, thermal conductivity, EMI shielding and corrosion resistance. A conductive metal core, including any of a Copper or Aluminum, is provided, over which is applied at least one polymer based layer incorporating a Graphene, functionalized Graphene, carbon nanotube, nano-material, MXene material or electrically conductive filler. In a preferred embodiment, a first thermally conducting polymer insulation layer coating is applied over the conductive metal core, with a second EMI resistant layer applied over the first insulation layer. At least one of the polymer layers further includes any of a flame retardant or intumescent coating.

### CROSS REFERENCE TO RELATED APPLICATIONS

The present application claims the priority of U.S. Ser. No. 63/651,482 filed May 24, 2024.

### FIELD OF THE INVENTION

The present invention relates generally to vehicle busbar applications. More specifically, the present invention teaches improvements in busbar applications for EV vehicle applications and which includes a copper or aluminum core over which is extruded one or more insulating polymer coatings, which provide flame retardant properties along with improved functionality, enhanced shielding and enhanced thermal conductivity. The coatings can include Graphene, functionalized Graphene nanoparticles, carbon nanotube, nano-material, MXene material, as well as electrically conductive fillers.

### BACKGROUND OF THE INVENTION

With a steady increase in popularity of electric vehicles (EV), it is important to consider critical safety measures to protect high voltage power systems. As is known, busbars conduct electrical current through the major electrical pathways of a battery electric vehicle and serves as a module connection in the battery pack. Busbars offers unique advantages in terms of efficient integration in tightly spaced Battery Management Systems (BMS).

A solid busbar is a typically rectangular piece of metal manufactured from either copper or aluminum plate. An insulating resin coating is also provided and may be electroplated at the ends for providing corrosion resistance at the connection junctions.

Increasing demands for battery fast charging, as well as higher vehicle range essentially means higher amount of conducted current for a fixed time-frame which in turn can lead to heating and copper losses. While traditional battery cooling strategies are being developed to address these issues, a more thermally efficient busbar insulating coating will contribute positively towards battery pack cooling.

Other considerations include electromagnetic interference (EMI), which can plague busbars in two ways: higher switching frequencies from future inverters and by proximity effect between closely packed busbars. Existing literature further indicates use of a Copper or Aluminum tube over the insulation layer for EMI shielding and other instances where graphene coating or sheathing is applied on top of an insulating layer for the EMI shield.

### SUMMARY OF THE INVENTION

The invention describes a multilayer Busbar coating system, in which individual layers are tailored to address functional requirements of electrical insulation, thermal conductivity/heat dissipation, EMI shielding and corrosion resistance. A conductive metal core is provided, such as constructed from Copper or Aluminum, over which is applied at least one polymer-based layer incorporating any of a Graphene, functionalized Graphene, carbon nanotube, nano-material, MXene material, as well as any electrically conductive filler. In this manner, a multi-layer composite polymer Busbar coating improves heat dissipation as well as provides EMI shield effect.

In a preferred embodiment, a first polymer insulation layer coating is applied over the conductive metal core, with a second EMI resistant layer applied over the first insulation layer, at least one of the first and second layers incorporating the Graphene, functionalized Graphene, carbon nanotube, nano-material, MXene material, as well as any electrically conductive filler.

At least one of the first and second polymer layers of the coating further includes a flame retardant or other intumescent coating which during operation, which assists in preventing degradation of the polymer coatings.

A flow-coating process may be used to coat the busbar with a solvent-borne Graphene enhanced organic coating. An extrusion process can be provided for applying the polymer layer upon the metal core.

A hot-dip process can be used to coat the metal core with a Zn—Al alloy (Galfan), such as in an in-line application, to prevent corrosion. The metal core can be plated or coated as one continuous in-line process prior to extrusion of at least one polymer layer to prevent corrosion. The polymer layers that serve as an electrically insulating coating can also include a thermally conductive filler material.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a first perspective illustration of a single layer insulation coated busbar according to a non-limited embodiment of the present invention;

FIG. 2 presents a cutaway view taken along line 2-2 of FIG. 1 and depicting the insulation coating extruded about the metal core from another angle;

FIG. 3 is a perspective illustration of a dual layer coated busbar according to a further non-limited variant and including an inner insulation layer and an outer EMI resistant layer according to a further non-limited embodiment of the present invention; and

FIG. 4 presents a cutaway view taken along line 4-4 of FIG. 3 similar to that shown in FIG. 2 and depicting the double layer extruded for the busbar from another angle.

### DETAILED DESCRIPTION OF THE PREFERRED EMBODIMENTS

With reference to the attached illustrations, the present invention discloses a multilayer Busbar coating system which includes one or more individual layers tailored to address functional requirements of electrical insulation, thermal conductivity/heat dissipation, EMI shielding, enduring polymer adhesion to the core and corrosion resistance.

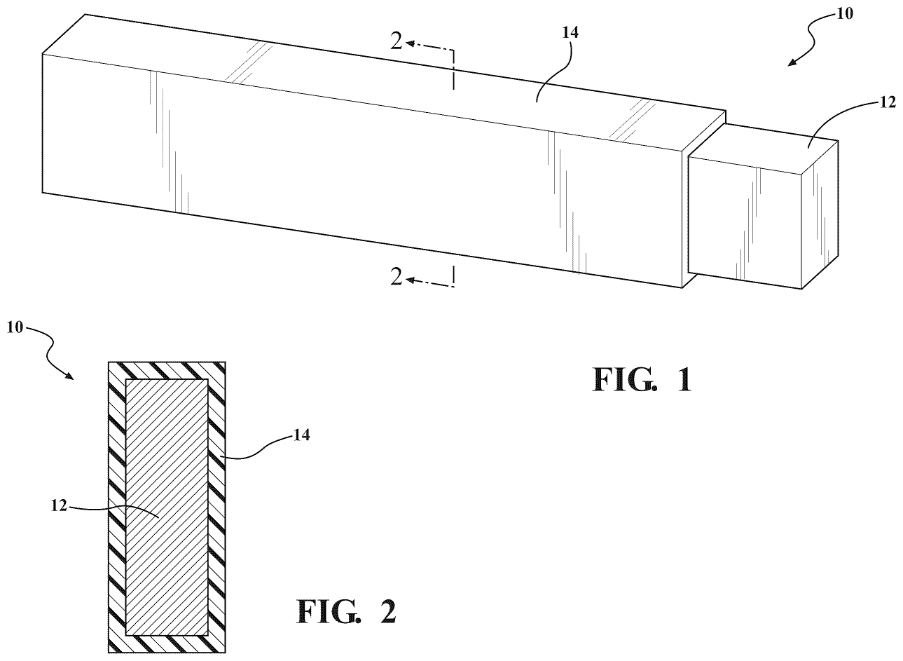

FIG. 1 is a first perspective illustration of a single layer insulation coated busbar, generally at 10, according to a non-limited embodiment of the present invention, with FIG. 2 presenting a cutaway view taken along line 2-2 of FIG. 1. The busbar includes an elongated copper or aluminum metal core 12, such as including a rectangular cross sectional shape as shown but also including circular, oval or any other desired shaping. At least one extruded polymer insulating coating 14 (or multiple coatings) is applied over the metal core 12 and can incorporate any of a Graphene, functionalized Graphene, carbon nano-tubes, nano-metals, MXenes, as well as any electrically conductive filler integrated in any form, such as powdered, in to the extruded polymer mixture. This includes the Graphene coating or sheathing being applied on top of the insulating layer for providing EMI shielding. Polymer coatings applied via extrusion on a conductive metal core will exhibit sufficient adhesion to the substrate so that no mechanical deformation or air pockets are observed during post-production processing steps.

Without limitation, the coating may also include a flow-coating process incorporating a solvent-borne Graphene enhanced organic coating. In a further specific example, a hot-dip process can may be used to coat the busbar with a Zn—Al (Galfan) alloy to prevent corrosion, such as in an in-line application.

The insulation layer 14 can also include a thermally conductive polymer or conductive filler material that can serve as an electrically insulating coating. The insulating layer 14 can also be impregnated with flame-retardants or other intumescent coatings (i.e. defined as a material which swells in response to heat exposure) for addressing thermal runaway situations. In operation, the use of effective fire retardants assists in preventing degradation of the polymer coatings.

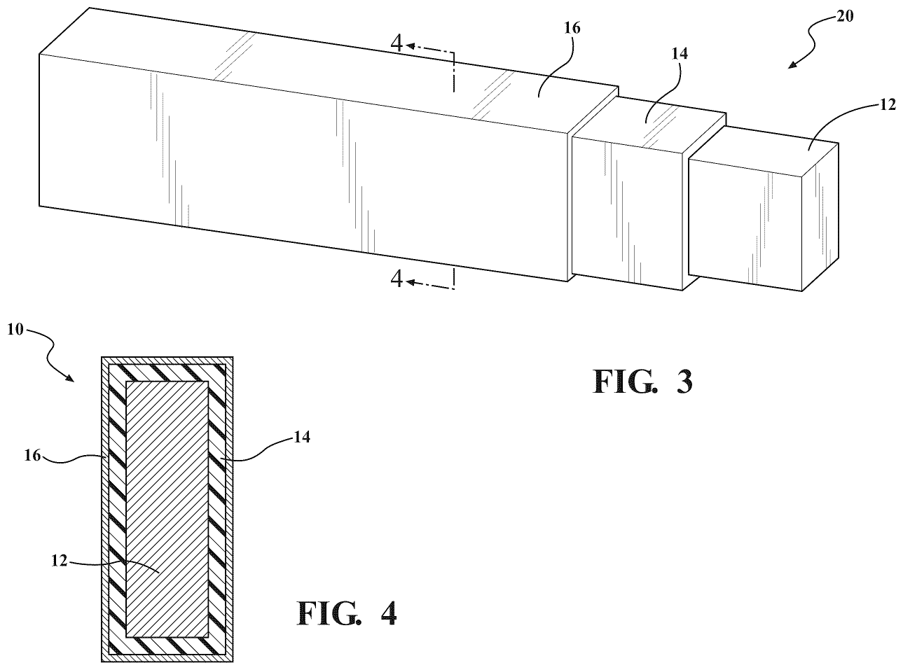

Proceeding to FIG. 3, a second perspective illustration is shown generally at 20 of a dual layer coated busbar including the inner insulation layer 14 of FIGS. 1-2, along with an outer EMI resistant layer 16 according to a further non-limited embodiment of the present invention, with FIG. 4 presents a cutaway view taken along line 4-4 of FIG. 3. A Copper or Aluminum metal core, again at 12, is provided with extruded multilayer polymers as coatings applied (i.e. extruded) over the metal core. The multilayer coatings (again including the insulation layer 14 and outermost EMI resistant layer 16) may consist of flame retardants or intumescent coatings, as well as again graphene, functionalized graphene, carbon nano-tubes, nano-materials, MXene materials, other nanoparticles, or other electrically conductive fillers.

As previously described, the core metal strip 12 may be coated or plated to prevent corrosion, and in the second embodiment can again include a flow-coating process to coat the busbar with a solvent-borne Graphene enhanced organic coating. A hot-dip process may again be used to coat the busbar with a Zn—Al alloy to prevent corrosion.

Additionally, one of electrically insulating coating layers may include a thermally conductive polymer material or conductive filler. The polymer may again be reinforced with Graphene, functionalized Graphene, carbon nanotubes, nano-materials or Mxene materials (these defined as a class of two-dimensional inorganic compounds that consist of atomically thin layers of transition metal carbides, nitrides, or carbonitrides), to provide EMI shielding as well as again can also be impregnated with flame retardants/intumescent coatings for protecting against thermal runaway situations.

Without limitation, the EMI shielding aspect can be incorporated into, as shown in FIGS. 3-4, the second outer layer 16 as shown by incorporating nano-fillers in the polymer matrix. Additionally, the layers 14 or 16 may either or both be impregnated with flame retardants for addressing thermal runaway situations. Beyond that shown, it is also understood that any number of extruded or coextruded coatings of polymer can be applied over the metal core 12 within the scope of the present invention.

Having described my invention, other and additional preferred embodiments will become apparent to those skilled in the art to which it pertains, and without deviating from the scope of the appended claims. The detailed description and drawings are further understood to be supportive of the disclosure, the scope of which being defined by the claims. While some of the best modes and other embodiments for carrying out the claimed teachings have been described in detail, various alternative designs and embodiments exist for practicing the disclosure defined in the appended claims.

The foregoing disclosure is further understood as not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosure. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application. Additionally, any signal hatches in the drawings/figures should be considered only as exemplary, and not limiting, unless otherwise specifically specified.

1. A busbar, comprising:
a conductive metal core; and
at least one polymer based layer applied over said metal core and incorporating any of a Graphene, functionalized Graphene, carbon nanotube, nano-material, MXene material or electrically conductive filler.

2. The busbar according to claim 1, said conductive metal core further comprising any of a Copper or Aluminum.

3. The busbar according to claim 1, said at least one polymer layer further comprising any of a flame retardant or intumescent coating.

4. The busbar according to claim 1, further comprising said Graphene, functionalized Graphene, carbon nanotube, nano-material, MXene material or electrically conductive filler being incorporated into a solvent-borne coating or as additive filler into the polymer matrix which is then applied via extrusion.

5. The busbar according to claim 1, further comprising an extrusion process for applying said at least one polymer layer upon said metal core.

6. The busbar according to claim 1, further comprising a hot-dip process used to coat said metal core with a Zn—Al alloy to prevent corrosion.

7. The busbar according to claim 1, further comprising said metal core being plated or coated as one continuous in-line process prior to extrusion of said at least one polymer layer to prevent corrosion.

8. The busbar according to claim 1, said at least one polymer layer further comprising a thermally conductive material that can serve as an electrically insulating coating.

9. The busbar according to claim 1, further comprising said at least one polymer layer providing EMI shielding.

10. A busbar, comprising:
a conductive metal core;
a first polymer insulation layer coating applied over said conductive metal core;
a second EMI resistant layer applied over said first insulation layer; and
at least one of said first and second layers incorporating any of Graphene, functionalized Graphene, carbon nanotube, nano-material, MXene material or electrically conductive filler.

11. The busbar according to claim 10, said conductive metal core further comprising any of a Copper or Aluminum.

12. The busbar according to claim 10, at least one of said first and second polymer layers further comprising any of a flame retardant or intumescent coating.

13. The busbar according to claim 10, comprising said Graphene, functionalized Graphene, carbon nanotube, nano-material, MXene material or electrically conductive filler being incorporated into a solvent-borne coating or as additive filler into the polymer matrix which is then applied via extrusion.

14. The busbar according to claim 10, further comprising an extrusion process for applying said at least one polymer layer upon said metal core.

15. The busbar according to claim 10, further comprising a hot-dip process used to coat said metal core with a Zn—Al alloy to prevent corrosion.

16. The busbar according to claim 10, further comprising said metal core being plated or coated as one continuous in-line process prior to extrusion of said at least one polymer layer to prevent corrosion.

17. The busbar according to claim 10, said at least one polymer layer further comprising a thermally conductive material that can serve as an electrically insulating coating.

18. The busbar according to claim 10, said second EMI resistant layer further comprising a polymer with nano-fillers coextruded over said first insulation layer.
